(19) United States
(12) Patent Application Publication
(10) Pub. No.: US 2008/0075655 A1
(43) Pub. Date: Mar. 27, 2008

(54) Gas mixing device and methods of use

(76) Inventors: Lev Davydov, Lyndhurst, NJ (US); Weibin Jiang, Clinton, NJ (US); Jason Norman, Hoboken, NJ (US); Bruce Uhlman, Mount Arlington, NJ (US)

Correspondence Address: THE BOC GROUP, INC., 575 MOUNTAIN AVENUE, MURRAY HILL, NJ, 07974-2064, US

(21) Appl. No.: 11/525,063

(22) Filed: Sep. 21, 2006

(51) Int. Cl. C01B 3/26; B05B 7/06

(52) U.S. Cl. 423/651; 239/427; 239/428

(57) ABSTRACT

The present invention provides for a gas mixing device and its use in a catalytic partial oxidation reactor. The gas mixing device is typically an eductor such as a venturi-type eductor which will mix the feed gases used in the catalytic partial oxidation process. Two gas mixing devices may be used in sequence.

### BACKGROUND OF THE INVENTION

The present invention provides for a gas mixing device and its use in mixing the feed reactants for a catalytic partial oxidation reaction. More particularly the present invention provides for a gas mixing device employing an eductor to mix the gases to feed to a catalytic partial oxidation reactor.

The conversion of hydrocarbons to hydrogen and carbon monoxide-containing gases is well known in the art. Examples of such processes include catalytic steam reforming, auto-thermal catalytic reforming, catalytic partial oxidation and non-catalytic partial oxidation. Each of these processes has advantages and disadvantages and produces various ratios of hydrogen and carbon monoxide together, also known as synthesis gas or syngas.

Partial oxidation processes are also well known and the art is replete with various catalytic partial oxidation processes. Partial oxidation is an exothermic reaction wherein a hydrocarbon gas, such as methane, and an oxygen-containing gas, such as air, is contacted with a catalyst at elevated temperatures to produce a reaction product containing high concentrations of hydrogen and carbon monoxide. The catalysts used in these processes are typically noble metals, such as platinum or rhodium, and other transition metals, such as nickel, on a suitable support.

Partial oxidation processes convert hydrocarbon-containing gases, such as natural gas, to hydrogen, carbon monoxide, and other trace components such as carbon dioxide and water. The process is typically carried out by injecting preheated hydrocarbons and an oxygen-containing gas into a combustion chamber where oxidation of the hydrocarbons occurs with less than stoichiometric amounts of oxygen for complete combustion. This reaction is conducted at very high temperatures, often in excess of 700° C. and often in excess of 1,000° C., and pressures up to 150 atmospheres. In some reactions, steam or carbon dioxide can also be injected into the combustion chamber to modify the synthesis gas product and to adjust the ratio of hydrogen to carbon monoxide in the final product.

More recently, partial oxidation processes have been disclosed in which the hydrocarbon gas is contacted with an oxygen-containing gas at high space velocities in the presence of a catalyst such as a metal deposited on a ceramic foam (monolith) support. The monolith supports are impregnated with a noble metal such as platinum, palladium or rhodium, or other transition metals such as nickel, cobalt, chromium and the like. Typically, these monolith supports are prepared from solid refractory or ceramic materials such as alumina, zirconia, magnesia and the like. During operation of these reactions, the hydrocarbon feed gases and oxygen-containing gases are initially contacted with the metal catalyst at temperatures in excess of 400° C., typically in excess of 600° C., and at a standard gas hourly space velocity (GHSV) of over 100,000 per hour.

One of the requirements typically set forth for an efficiently functioning catalytic monolith reactor is the mixing of gases that enter the reactor. The complete mixture of gases assures the uniform heat transfer in the reactor as well as the uniform conversion of reactants to products. Further, the complete mixing of gases reduces the likelihood of local regions of flammable composition forming. Conventionally, such mixing is administered via mixing tees that bring together the two gas flows. More recently, static mixers, which consist of a multitude of internal vanes, have been utilized for thorough mixing of gases entering the reactor. The gas flows are merged at a t-union and then enter the static mixer and the turbulence, which are induced by the vanes of the static mixer, assure that the reactants are completely mixed. The flow in the static mixer, however, undergoes strong impingement on the vanes of the mixer which can cause flammability hazards when gaseous fuels are mixed with oxidizers. There is a need in the art to provide a thorough mixing of the reactant gases prior to their feed to a catalytic partial oxidation reactor while avoiding the flammability hazards associated with previous mixing processes.

### SUMMARY OF THE INVENTION

The present invention provides for a gas mixing device which comprises an eductor means having a first gas inlet and a second gas inlet. Preferably the eductor means comprise a venturi-type eductor. The gas mixing device is in fluid communication with the gas inlets which will allow inputting of the various reactants for catalytic partial oxidation processes and a catalytic partial oxidation reactor.

In an alternative embodiment two gas mixing devices can be in fluid communication with each other prior to their feeding the mixed gas to the catalytic partial oxidation reactor.

The present invention also provides for the use of the gas mixing means in the catalytic partial oxidation of hydrocarbons to produce hydrogen and carbon monoxide. This process will employ the gas mixing means for mixing the hydrocarbon-containing gas stream and the oxygen-containing gas stream prior to their being fed to the catalytic partial oxidation reactor.

In a further embodiment of the present invention, there is disclosed an improved process for the catalytic partial oxidation of hydrocarbons wherein feedstream of hydrocarbon-containing gases and oxygen-containing gases are fed to a catalytic partial oxidation reactor to produce hydrogen and carbon monoxide, the improvement comprising mixing the hydrocarbon-containing gas stream and the oxygen-containing gas stream in a gas mixing device prior to their being fed to the catalytic partial oxidation reactor.

### BRIEF DESCRIPTION OF THE DRAWINGS

FIG. 1 is a schematic representation of one embodiment of the present invention showing the gas mixing means and the catalytic partial oxidation reactor.

FIG. 2 is a schematic representation of the present invention showing two gas mixing means in communication prior to entry of the gas mix into a catalytic partial oxidation reactor.

### DETAILED DESCRIPTION OF THE INVENTION

A gas mixing device which comprises eductor means having a first gas inlet and a second gas inlet is described in one embodiment of the present invention. The eductor means are preferably a venturi-type eductor and the eductor means will have a first opening and a second opening both at opposite ends to each other and in fluid communication. The gas mixing device is also in fluid communication with a reactor where the gaseous feed streams that are mixed in the gas mixing device will react. Preferably this is a catalytic partial oxidation reactor. The first gas inlet and the second gas inlet can be employed for feeding the various gaseous feedstreams that will be used in the reactor for mixing.

In an alternative embodiment, the gas mixing device may be two gas mixing devices in fluid communication with each other to ensure the adequate mixing of the input gases prior to their being fed to a catalytic partial oxidation reactor. This will significantly reduce the flammability risk by minimizing the potential of oxygen enriched areas being present. Other advantages of this arrangement of two gas mixing devices is that they can be employed in tuning the various reactant gas streams such that the proper desired ratio of carbon monoxide to hydrogen is achieved. This tuning of the ratio of carbon monoxide to hydrogen is accomplished by the addition of an inert gas into the second stage device. The gas mixing device may be used in a process for the catalytic partial oxidation of hydrocarbons to produce hydrogen and carbon monoxide which comprises feeding to the gas mixing device a first feedstream of a hydrocarbon-containing gas, which is typically a C₁ to C₄ alkane, and a second feedstream of an oxygen-containing gas, typically air. The two feedstreams are mixed in the gas mixing device and fed from the gas mixing device to the catalytic partial oxidation reactor.

In a further alternative embodiment of the present invention, an improved process for the catalytic partial oxidation of hydrocarbons wherein feedstreams of hydrocarbon-containing gases and oxygen-containing gases are fed to a catalytic partial oxidation reactor to produce hydrogen and carbon monoxide, the improvement comprising mixing the hydrocarbon-containing gas stream and the oxygen-containing gas stream in a gas mixing device prior to their being fed to the catalytic partial oxidation reactor is disclosed.

The eductor means may be selected from those eductor types that will provide the appropriate motive force to the gas feedstreams being mixed. For example, a jet eductor will lift, entrain and pump out a low pressure fluid utilizing a high pressure motive fluid. Other examples of eductors include gas/steam motive eductors such as those available Penberthy under their GL Series, liquid motive eductors, such as those available from Penberthy under their LL Series and steam heating and mixing eductors such as those available from Penberthy under their ELL Series and CTE Series. Typically these eductors are constructed from materials such as cast-iron, steel, stainless steel, bronze, plastics and other alloy materials.

The catalytic partial oxidation reactor will contain a reduced metal catalyst. The metal catalyst employed in the present invention consists of a ceramic monolith support structure composed of ceria coated on zirconia substrate and coated or impregnated with a transition metal or combinations thereof. The monolith support is generally a ceramic foam-like structure formed from a single structural unit wherein the passages are disposed in either an irregular or regular pattern with spacing between adjacent passages. The single structural unit is used in place of conventional particulate or granular catalysts, which are less desirable. Examples of such irregularly patterned monolith supports include filters used for molten metals. Examples of regularly patterned supports include monolith honeycomb structures used for purifying exhausts from motor vehicles and used in various chemical processes. Preferred are the ceramic foam structures having irregular passages. Both types of monolith supports are well known and readily available commercially.

The catalyst element consists of a ceramic foam monolith composed substantially of zirconia, coated with about 15 to 20 wt. % ceria providing surface area for the metal impregnation, and contains 0.5 to about 5 wt. % noble metal, which is preferably rhodium in metallic form, and most preferably about 2 wt. % rhodium. Optionally, a transition metal, such as nickel at 2 to 4 wt. % may be used by itself or in combination with the rhodium. The reactor can also contain several ceramic foam disks including those with catalyst impregnated on them and with blanks to fill the void space. The blanks may be made of alumina, zirconia, cordierite or mixtures thereof. The blanks may be spaced and sized according to their effect on flow distributions and the desired final mixing step.

Optionally, the reduced metal catalyst consists of a transition metal selected from the group consisting of nickel, cobalt, iron, platinum, palladium, iridium, rhenium, ruthenium, rhodium, osmium and combinations thereof all supported on or in a ceria-coated zirconia monolith support.

The gas feedstreams that are mixed in the gas mixing device are fed to the reactor at pressures of between about 1 to about 30 atmospheres. They also may be fed at a standard gas hourly space velocity of about 50,000 to about 500,000 per hour and typically at temperatures greater than 100° C.

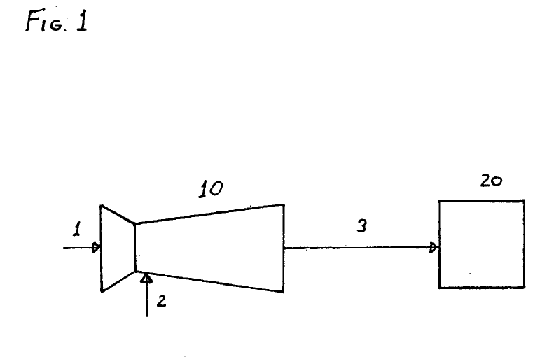

Turning to the figures, FIG. 1 is a schematic representation of the present invention showing the gas mixing device 10 in fluid communication with the catalytic partial oxidation reactor 20. The hydrocarbon gas is fed into line 1. The hydrocarbon gas may be a C₁ to C₄ alkane, preferably is methane, and can be present along with an inert gas such as nitrogen, carbon dioxide, argon, helium or steam. The oxygen-containing gas is fed through line 2. The oxygen-containing gas can be any mixture which contains oxygen in a percentage to allow oxidation to occur. The tunability of the catalytic partial oxidation process depends in part on the amount of oxygen present in the reaction and accordingly, this can be adjusted by feeding air or pure oxygen into line 2. Alternatively, the hydrocarbon gas may be fed through line 2 while the oxygen-containing gas is fed through line 1. Mixing occurs within the gas mixing means 10 and the mixed feedstreams will exit through line 3 and enter the reactor wherein catalytic partial oxidation will occur to produce a gas mixture of hydrogen, carbon dioxide, water vapor and carbon monoxide.

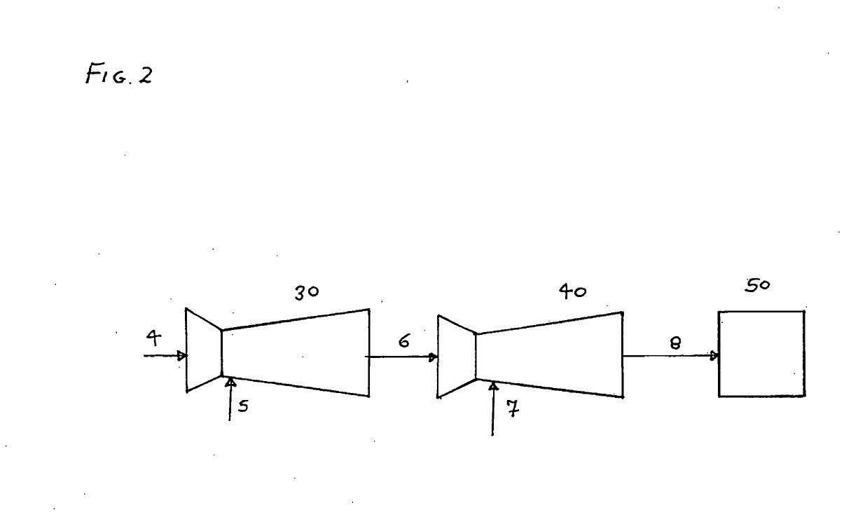

FIG. 2 is a schematic representation of the present invention showing a second gas mixing means 40 along with the first gas mixing means 30. The use of a secondary gas mixing device or eductor means is necessary when the mixing takes place at high pressure which is known to widen the flammability envelope. The hydrocarbon-containing gas is fed from line 4 into the first gas mixing means 30. The oxidizer or oxygen-containing gas may be fed in part or in whole to line 7 to the gas mixing means 30. Depending upon how the issue of flammability is to be dealt with, the oxygen-containing gas flowing into line 5 can be the full amount necessary for the catalytic partial oxidation reaction or it can be in part split between line 5 and line 7 which enters into the second gas mixing means 40. When all the oxygen-containing gas is fed to line 5 and first gas mixing means 30, an inert gas such as nitrogen, carbon dioxide or steam may be fed through line 7 to help arrest the flammability envelope. The mixed gas feedstreams will exit the first gas mixing device through line 6 and enter the second gas mixing means 40. The sum of all gases now fed into the system whether it is the hydrocarbon-containing gas, an oxygen-containing mixture, or the hydrocarbon-containing gas, oxygen-containing gas and inert gas are mixed thoroughly in the second mixing means 40 and will exit through line 8 where they are fed to the catalytic partial oxidation reactor 50 wherein catalytic partial oxidation of the gas feedstream mixtures will occur and produce a gas rich in hydrogen and carbon monoxide.

In order to illustrate the workability of the present invention, computer flow dynamic (CFD) simulations were conducted. CFD modeling was used to evaluate the geometry and size of mixing devices, for example, mixing tees, static mixers and eductors, in the creation of a fully mixed flow out of two or more individual flows.

The modeling was done through the numerical solution of Navier-Stokes equation using finite volume or finite element schemes for the meshed domain. This way the velocity value and direction was calculated and species concentration was balanced for each cell (or node) of the mesh. Although CFD modeling can be used to perform various evaluations, the following information is essential for the monolith pre-mixing design: velocity fields in the computational domain and concentration profiles of various species in the mixing device and the pipework following the mixing device.

Velocity fields provide insight in the flow patterns including presence of any back flow, channeling, stagnation zone(s), dispersion and deviation from ideal flows. These fields can be generated for the whole domain where fluid motion takes place. The velocity field can be represented by velocity contours as well as velocity vectors. These graphs are used in designing the mixing device of the present invention. The longitudinal velocity profiles and vectors can identify the areas of turbulence, flow short-circuiting and stagnation. Given this information the changes in the equipment selection are introduced to optimize the turbulence of the fluid flow inside the mixing device, especially in the mixing areas. The knowledge of the flowfield inside the mixing device also allows to compare the local gas velocities with the sonic velocity at the identical conditions to assure the long-term integrity of the mixing device. Similar comparison with the flame velocity can aid in the assessment of local flammability.

Yet another important component of CFD modeling is species transport. The uniform distribution of the species in the outgoing flow is the ultimate measure of the mixing efficiency for a particular mixing device. The convective (as well as molecular) and turbulent diffusion of species is essential when two or more components are mixed. The typical output of species modeling is generated in the form of concentration profiles. Cross sectional and longitudinal concentration profiles help to assure the adequate mixing of components inside the equipment and introduce changes into the equipment design and size should the mixing be inadequate.

CFD simulations can be run in an unsteady state mode when the assessment of transient processes (including reactor start-up and shutdown) is required. Such analysis allows for modeling flammable pocket formation in real time (should such formation take place). It also facilitates in the determination of the optimal flow arrangement for the mixing device.

Three generic configurations were considered: a mixing tee, static mixer, and an eductor. As the gases that are employed in the catalytic partial oxidation process mix inside these three fixtures, a certain fraction of the gas can attain a flammable concentration. When a mixing tee is used, the pocket of flammable gas propagates co-currently with the flow direction. Should a spark occur somewhere in the system, such arrangement can lead to flame propagation. When a static mixer is used, the pocket of flammable gas repeatedly hits the internal vanes of the static mixer perpendicular to the flow. This condition can create local overheating of the gas where it impinges on the vanes and can serve as ignition sources and cause the flame to propagate. The above observed phenomena were not noticed when an eductor is utilized for the gas mixing means. The use of an eductor leads to the smallest of the three non-propagating flammable regions during mixing of the gases, thus lessening the hazards associated with synthesis gas production. Furthermore, the area of highest velocity of gas inside the eductor is contained by the thickest walls which provide for additional safety if an ignition source emerges. The highest velocity is also a critical parameter in ensuring that the gas velocity is greater than the flame velocity.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the present invention.

Having thus described the invention, what we claim is:

1. A gas mixing device comprising eductor means having a first gas inlet and a second gas inlet.

2. The gas mixing device as claimed in claim 1 wherein said eductor means is selected from the group consisting of venturi-type eductors, gas/steam motive eductors, liquid motive eductors and steam heating and mixing eductors.

3. The gas mixing device as claimed in claim 1 wherein said eductor means comprises a first opening on one end in fluid communication with a second opening on the opposite end of said gas mixing device.

4. The gas mixing device as claimed in claim 1 fluidly connected to a second eductor means.

5. The gas mixing device as claimed in claim 1 fluidly connected to a reactor.

6. The gas mixing device as claimed in claim 5 wherein said reactor is catalyst monolith reactor.

7. A process for the catalytic partial oxidation of hydrocarbons to produce hydrogen and carbon monoxide comprising feeding to a gas mixing device a first feedstream of a hydrocarbon-containing gas and a second feedstream of an oxygen-containing gas; mixing said first and said second feedstreams in said gas mixing device and feeding said mixed first and said second feedstreams to a reactor containing a reduced metal catalyst.

8. The process as claimed in claim 7 wherein said gas mixing device is selected from the group consisting of venturi-type eductors, gas/steam motive eductors, liquid motive eductors and steam heating and mixing eductors.

9. The process as claimed in claim 8 wherein said eductor comprises a first opening on one end in fluid communication to a second opening on the opposite end of said gas mixing device.

10. The process as claimed in claim 7 wherein said gas mixing device is fluidly connected to a second eductor means.

11. The process as claimed in claim 10 wherein an inert gas is added to said second eductor means.

12. The process as claimed in claim 11 wherein said inert gas is selected from the group consisting of nitrogen, carbon dioxide, argon, helium, and steam.

13. The process as claimed in claim 7 wherein said gas mixing device is fluidly connected to said reactor.

14. The process as claimed in claim 7 wherein said gas mixing device has a first gas inlet and a second gas inlet.

15. The process as claimed in claim 14 wherein said first feedstream is fed to said first gas inlet and said second feedstream is fed to said second gas inlet.

16. The process as claimed in claim 7 wherein said mixed first and second feedstreams are fed to said reactor at a pressure of between 1 and 30 atmospheres.

17. The process as claimed in claim 7 wherein said mixed first and second feedstreams are fed to said reactor at a standard gas hourly space velocity of about 50,000 to about 500,000 per hour.

18. The process as claimed in claim 7 wherein the temperature of said mixed first and second feedstreams is greater than 100° C.

19. The process as claimed in claim 7 wherein said reduced metal catalyst consists essentially of a transition metal selected from the group consisting of nickel, cobalt, iron, platinum, palladium, iridium, rhenium, ruthenium, rhodium, osmium and combinations thereof supported on or in a ceria-coated zirconia monolith support.

20. The process as claimed in claim 19 wherein said ceria-coated zirconia monolith support is about 5% to about 30% ceria by weight.

21. The process as claimed in claim 19 wherein said transition metal is selected from the group consisting of rhodium and nickel.

22. The process as claimed in claim 7 wherein said reactor contains foam disks having said catalyst impregnated therein.

23. The process as claimed in claim 22 wherein said reactor contains blank foam discs which can be used as spacers with said foam discs having catalyst impregnated therein.

24. An improved process for the catalytic partial oxidation of hydrocarbons wherein feedstream of hydrocarbon-containing gases and oxygen-containing gases are fed to a catalytic partial oxidation reactor to produce hydrogen and carbon monoxide, the improvement comprising mixing the hydrocarbon-containing gas stream and the oxygen-containing gas stream in a gas mixing device prior to their being fed to the catalytic partial oxidation reactor.

25. The process as claimed in claim 24 wherein said gas mixing device is selected from the group consisting of venturi-type eductors, gas/steam motive eductors, liquid motive eductors and steam heating and mixing eductors.

26. The process as claimed in claim 25 wherein said eductor comprises a first opening on one end in fluid communication to a second opening on the opposite end of said gas mixing device.

27. The process as claimed in claim 24 wherein said gas mixing device is fluidly connected to a second eductor means.

28. The process as claimed in claim 24 wherein an inert gas is added to said second eductor means.

29. The process as claimed in claim 28 wherein said inert gas is selected from the group consisting of nitrogen, carbon dioxide, argon, helium, and steam.

29. The process as claimed in claim 24 wherein said gas mixing device is fluidly connected to said reactor.

30. The process as claimed in claim 24 wherein said gas mixing device has a first gas inlet and a second gas inlet.

31. The process as claimed in claim 29 wherein said first feedstream is fed to said first gas inlet and said second feedstream is fed to said second gas inlet.

32. The process as claimed in claim 24 wherein said mixed first and second feedstreams are fed to said reactor at a pressure of between 1 and 30 atmospheres.

33. The process as claimed in claim 24 wherein said mixed first and second feedstreams are fed to said reactor at a standard gas hourly space velocity of about 50,000 to about 500,000 per hour.

34. The process as claimed in claim 24 wherein the temperature of said mixed first and second feedstreams is greater than 100° C.

35. The process as claimed in claim 24 wherein said reduced metal catalyst consists essentially of a transition metal selected from the group consisting of nickel, cobalt, iron, platinum, palladium, iridium, rhenium, ruthenium, rhodium, osmium and combinations thereof supported on or in a ceria-coated zirconia monolith support.

36. The process as claimed in claim 34 wherein said ceria-coated zirconia monolith support is about 5% to about 30% ceria by weight.

37. The process as claimed in claim 34 wherein said transition metal is selected from the group consisting of rhodium and nickel.

38. The process as claimed in claim 24 wherein said reactor contains foam disks having said catalyst impregnated therein.

39. The process as claimed in claim 38 wherein said reactor contains blank foam discs which can be used as spacers with said foam discs having catalyst impregnated therein.
